(19) United States
(12) Patent Application Publication
(10) Pub. No.: US 2012/0069597 A1
(43) Pub. Date: Mar. 22, 2012

(54) PLANAR LIGHT SOURCE DEVICE HAVING LIGHT GUIDE PLATE WITH REFLECTIVE MEMBER

(76) Inventors: Naoya Sone, Yokohama-shi (JP); Takahiro Ito, Tokyo (JP); Nobuyuki Kobayashi, Sagamihara-shi (JP); Tokihiko Shinomiya, Osaka (JP)

(21) Appl. No.: 13/260,473

(22) PCT Filed: Mar. 19, 2010
(86) PCT No.: PCT/JP2010/054825

§ 371 Date: Sep. 26, 2011

(30) Foreign Application Priority Data
Mar. 26, 2009 (JP) 2009-076022

(51) Int. Cl. F21V 7/22; F21V 7/00

(52) U.S. Cl. 362/609

(57) ABSTRACT

A white highly-reflective layer is formed at both ends of a light incident edge face of a color-mixing region of a light guide plate to surround an LED. Alternately, an overhung portion may be overhung from both ends of the light incident edge face of the color-mixing region of the light guide plate by a same material thereof to surround the LED, and a white highly-reflective layer is formed at terminals of the overhung portion. Still further, an overhung portion may be overhung from both ends of the light incident edge face of the color-mixing region of the light guide plate by the same material thereof to surround the LED, and a specular highly-reflective layer made of metal such as silver or aluminum is formed at terminals of the overhung portion.

### TECHNICAL FIELD

The present invention relates to a surface light source apparatus used as a planar illumination apparatus such as a backlight of a liquid crystal display unit, a transparent-type advertising display backlight, a tracer light box unit, a Schaukasten (Roentgen light box) illumination unit or a ceiling lamp.

### BACKGROUND TECHNOLOGY

Recently, in order to improve contrast and reduce power consumption, a local dimming function for light-adjusting areas is added to a surface light source apparatus of a liquid crystal television set or the like. A surface light source apparatus having such a local dimming function may use a linear cold cathode fluorescent lamp or a linear hot cathode fluorescent lamp, as a surface light source apparatus (see: Patent Literatures 1, 2 and 3).

On the other hand, one or more point-like light sources are used as light sources of a Hg-free surface light source apparatus from an environmental point of view. For example, one type of point-like light source is a white light emitting diode (LED) formed by coating fluorescent substance onto a blue LED, and the other type of point-like light source is a set of a red LED, a blue LED and a green LED for adequately color-mixing red, blue and green monochromatic lights to obtain white-light.

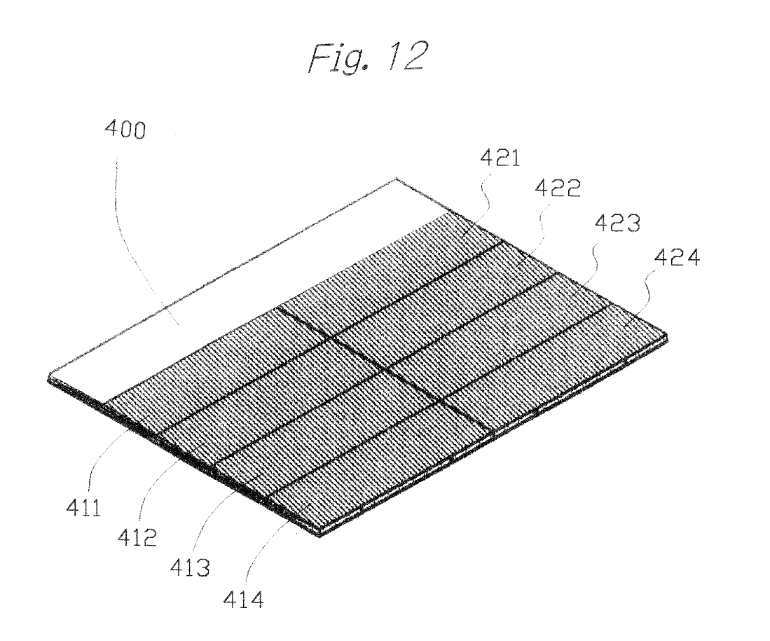

Therefore, Stanley Electric Co., Ltd., one of the co-applicants of this application, has already suggested a surface light source apparatus having a local dimming function using one or more point-like light sources (see: Patent Literature 4). This already-suggested surface light source apparatus is now explained by using FIGS. 12, 13 and 14.

FIG. 12 is a perspective view illustrating the already-suggested surface light source apparatus.

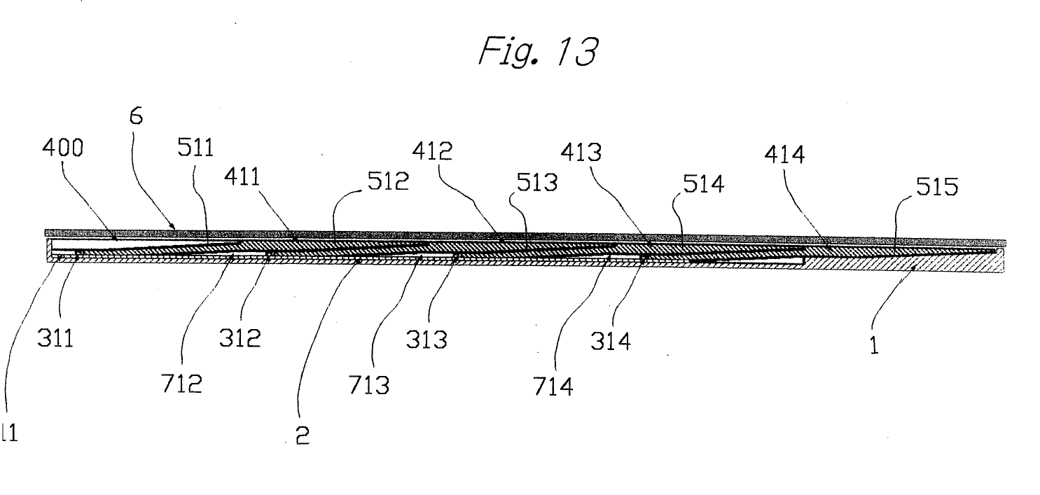

In FIG. 12, there are 2×4 tandem-arranged light guide plates 411, 412, 413, 414, 421, 422, 423 and 424 which are optically separated from each other, at a post stage of an initial-stage reflective plate 400. In FIG. 12, note that an optical sheet formed by a diffusion plate 6 (see: FIG. 13), a diffusion film, a prism sheet and a reflective polarizer plate (not shown) is provided on the initial-stage reflective plate 400 and the light guide plates 411, 412, 413, 414, 421, 422, 423 and 424.

FIG. 13 is a cross-sectional view of the surface light source apparatus of FIG. 12.

As illustrated in FIG. 13, provided within a housing 1 is an LED mounting substrate 2, and LEDs 311, 312, 313 and 314 are mounted on the LED mounting substrate 4 as primary light sources. Note that each of the LEDs 311, 312, 313 and 314 illustrates one or more LEDs representatively. The initial-stage reflective plate 400 and the light guide plates 411, 412, 413 and 414 are superposed onto each other, and reflective films 511, 512, 513, 514 and 515 are inserted therebetween so that leakage light which cannot be guided at a pre-stage light guide plate is reflected by the pre-stage light guide plate without being incident to a post-stage light guide plate.

Each of the LEDs 311, 312, 313 and 314 is mounted in LED accommodating regions 711, 712, 713 and 714 to face the incident edge of the light guide plates 411, 412, 413 and 414.

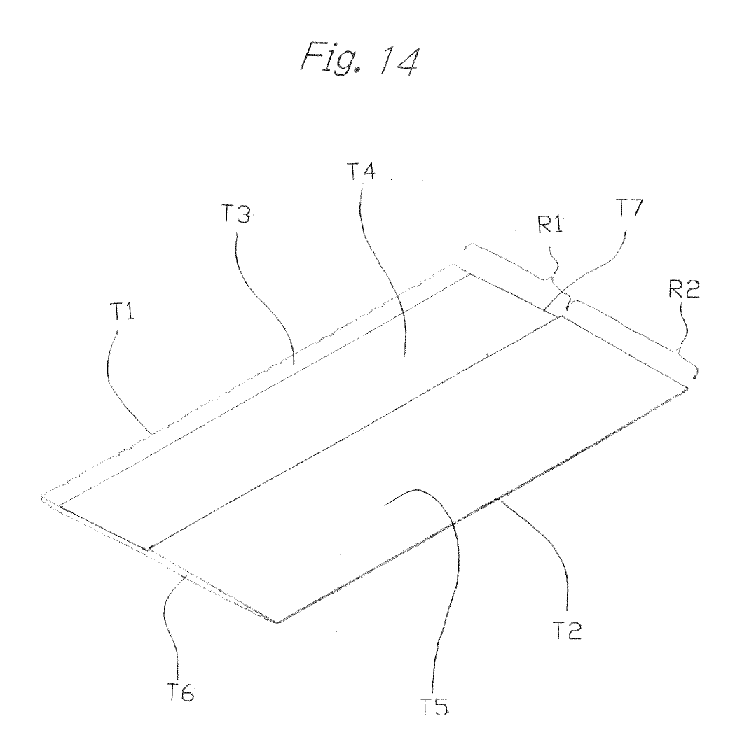

FIG. 14 is a perspective view of the light guide plate such as 411 of FIG. 12.

As illustrated in FIG. 14, the light guide plate such as 411 has a light incident edge face T1 for receiving light emitted from a plurality of LEDs, an opposite light incident edge face T2, a planar face T3, a sloped face T4, a light emitting face T5, a side face T6, a side face T7 and a bottom face T8. The planar face T3, the sloped face T4, a part of the side face T6 and a part of the side face T7 form a color-mixing region R1, and the light emitting face T5, the remainder of the side face T6 and the remainder of the side face T7 form an available region R2.

The color-mixing region R1 of the light guide plate 411 is provided in order to color-mix available lights of monochromatic light LEDs provided at the light incident edge face T1, for example, to obtain white-light and/or in order to avoid the brightness non-uniformity, i.e., homogenize the brightness. On the other hand, the available region R2 of the light guide plate 411 is provided for emitting illumination light from the light emitting face T5.

Returning to FIG. 13, the available region R2 of the light guide plate such as 411 is provided to be superposed onto the color-mixing region R1 of the next-stage light guide plate 412, thus constituting a uniform luminance of surface light sources of the surface light source apparatus. Also, the light emitted from the available region R2 of one light guide plate is diffused and reflected by optical sheets formed by the diffusion plate 6 and the like, so that the brightness non-uniformity is suppressed by a so-called light recycle effect.

### PRECEDING TECHNICAL LITERATURES

### Patent Literatures

Patent Literature 1: Japanese Unexamined Utility Model Publication No. Sho 63-21906

Patent Literature 2: Japanese Unexamined Patent Publication No. Hei 11-288611

Patent Literature 3: Japanese Unexamined Patent Publication No. 2002-72204

Patent Literature 4: Japanese Patent Application No. 2008-063181 (Japanese Unexamined Patent Publication No. 2009-218175)

### SUMMARY OF THE INVENTION

### Problem to be Solved by the Invention

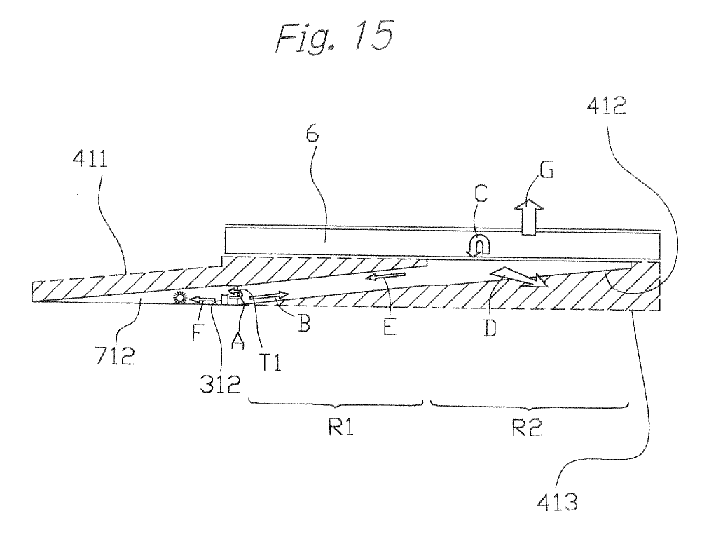

In the above-described already-suggested surface light source apparatus, however, there is a problem in that the utilization efficiency of light is low. This is explained with reference to FIG. 15. FIG. 15 illustrates the light guide plate 412 of FIG. 12.

As indicated by an arrow A, a part of light of the LED 312 as primary light is reflected by the light incident edge face T1 and returns to the LED accommodating region 712. The light luminous flux of this light A is about 10% of the emitted light of the LED 312.

As indicated by an arrow B and C, a part of the light incident to the light incident edge face T1 of the LED 312 as primary light passes the color-mixing region R1 and the available region R2 and is reflected within the diffusion plate 6 or at the boundary of the optical sheet. As indicated by an arrow D, a part of light guided through the color-mixing region R1 and the available region R2 and a part of the light reflected by the diffusion plate 6 or the boundary face of the optical sheet leak to their adjacent light guide plates. However, as indicated by an arrow E, remainder light is reflected by the opposite incident edge face T2 and the like so that the remainder light propagates through the color-mixing region R2 in the back direction. Therefore, as indicated by an arrow F, the remainder light reaches the LED accommodating region 711 where the remainder light is attenuated and absorbed.

As indicated by an arrow G, only light which is not absorbed by the interior of the diffusion plate 6 and the boundary of the optical sheet is outputted as available output light.

Thus, the return light as indicated by the arrow A reflected by the light incident edge face T1 and the return light as indicated by the arrows E and F back through the color-mixing region R1 are attenuated and absorbed in the LED accommodating region 712. That is, the LED accommodating region 712 forms an approximately triangular cavity in terms of structure. Therefore, even if the LED accommodating region 712 is surrounded by a highly-reflective film, when the return light is reflected by multiple reflections in this space, the return light is attenuated and absorbed. A simulation showed that 13.59 percent of the output luminous flux of the LED accommodating region 712 was attenuated and absorbed in the LED accommodating region 712. As a result, the available output light as indicated by the arrow G is about 63.2 percent of the output luminous flux of the primary light source (LED), so that the utilization of light of the above-described surface light source apparatus becomes low.

### Means for Solving the Problems

In order to solve the above-mentioned problems, a surface light source apparatus according to the present invention comprises at least one primary light source; a reflective element formed to surround the primary light source; and a light guide plate having a light incident edge face for receiving primary light from the primary light source, side faces for guiding light incident to the light incident edge face, an opposite light incident edge face located to oppose the light incident edge face, and a light emitting face for emitting guided light. Thus, return light in the light guide plate returns again by the reflective element to the light guide plate.

Also, the light guide plate comprises a color-mixing element including the light incident edge face and a part of the side faces, and an available element including the remainder of the side faces, the opposite light incident edge face and the light emitting face.

Further, the reflective element is made of white resin, and the light guide plate or the color-mixing element is made of transparent resin. The reflective element and the light guide plate are integrated by a double molding. Or, the reflective element is made of white polyethylene terephthalate (PET), and the light guide plate is made of transparent resin. The reflective element is bonded or welded on an overhung portion of the light incident edge face of the light guided plate. Or, transparent resin commonly used for optical use such as polymethylmethacrylate (PMMA) or the like may be molded or cut to form a light guide plate, and a metal film such as Al or Ag is grown on a portion for surrounding a light source of the light guide plate. Or, a metal film such as Ag or Al may be deposited by sputtering on a transparent resin substance such as polyethylene terephthalate (PET) and that metal film may be bonded to a portion for surrounding a light source at the light incident edge of a light guide plate.

### Effect of the Invention

When a reflective element having a reflectivity of 95 percent is provided at the back of the LED 312 of FIG. 15 to surround the LED 312, it was found that the output luminous flux of the LED 312 attenuated and absorbed in the LED accommodating region 712 was small, i.e., 4.48 percent of the luminous flux emitted from the LED 312. As a result, the available output light is large, i.e., about 70 percent of the output luminous flux of the primary light source (LED), and therefore, the utilization efficiency of light can be improved.

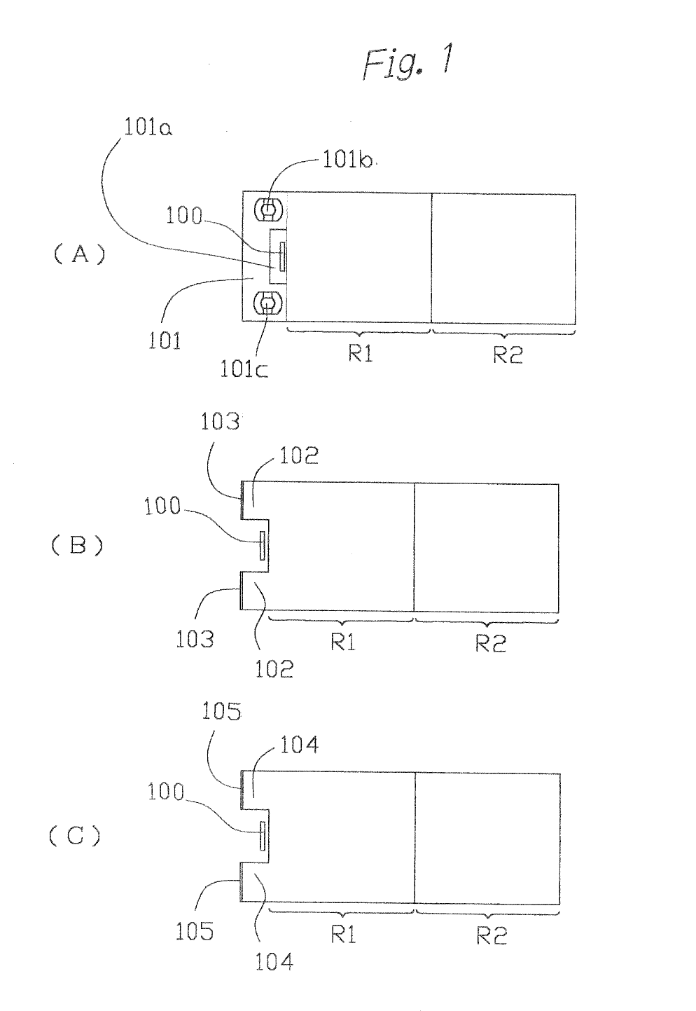

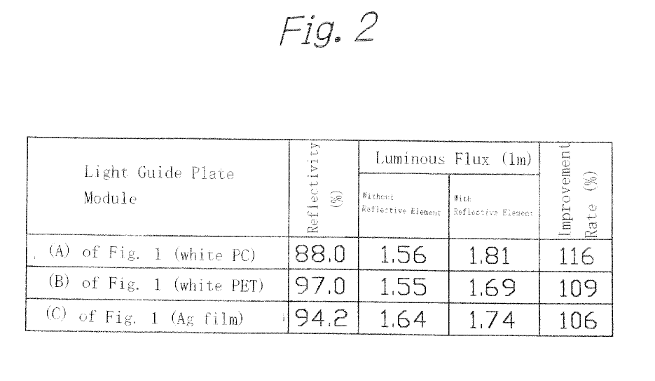

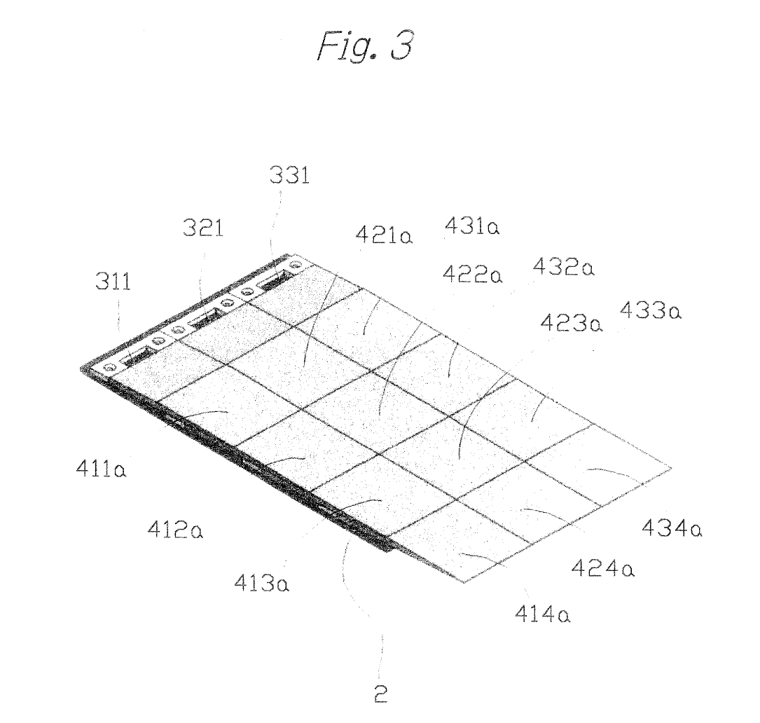

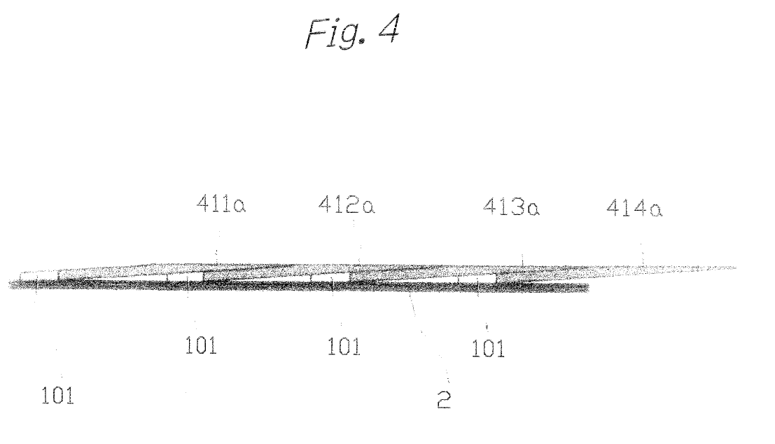

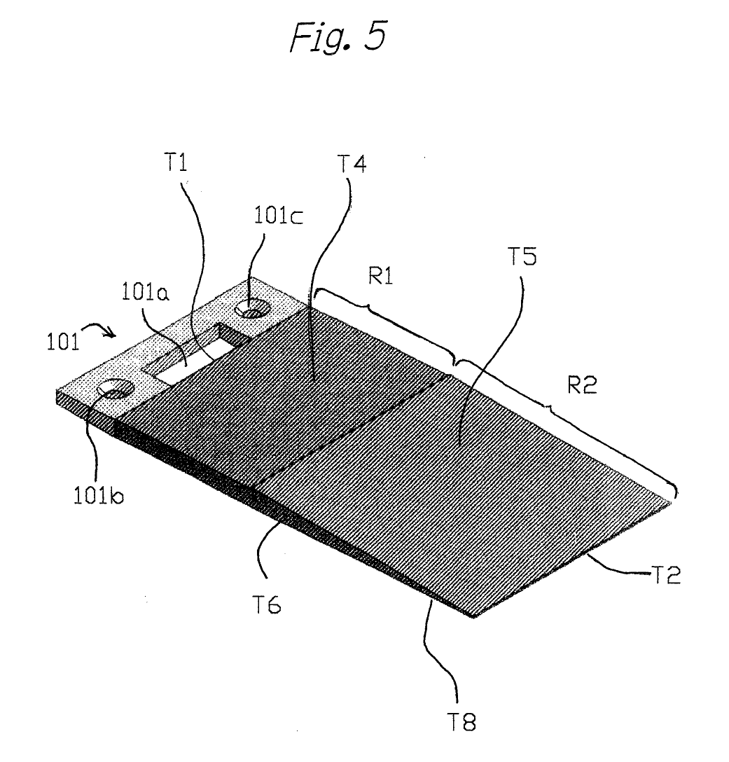

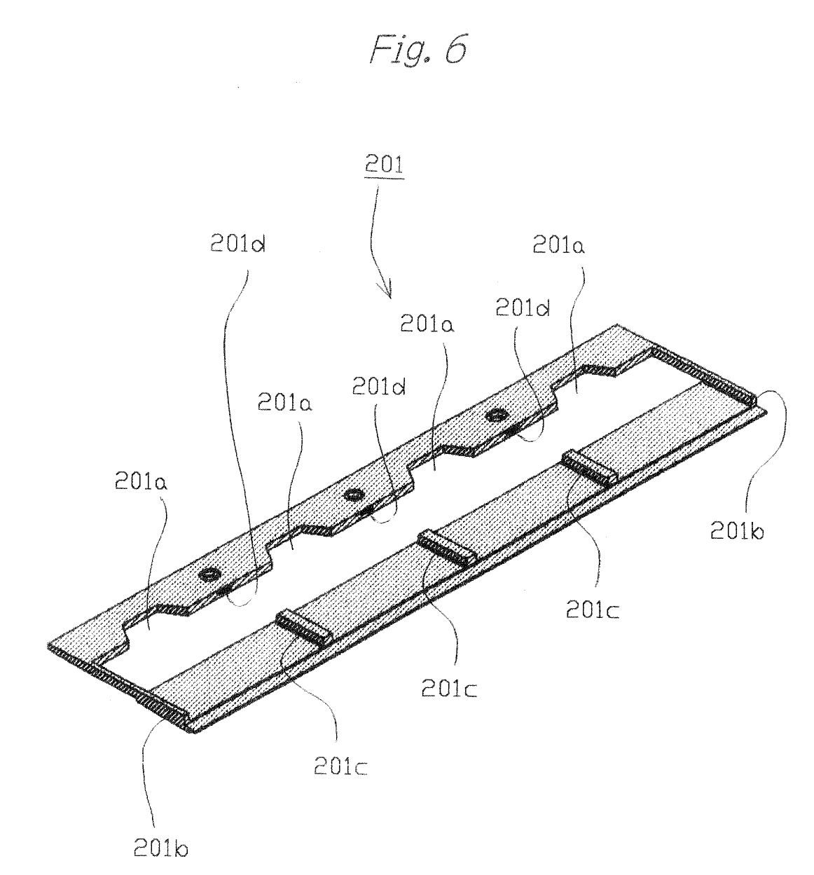

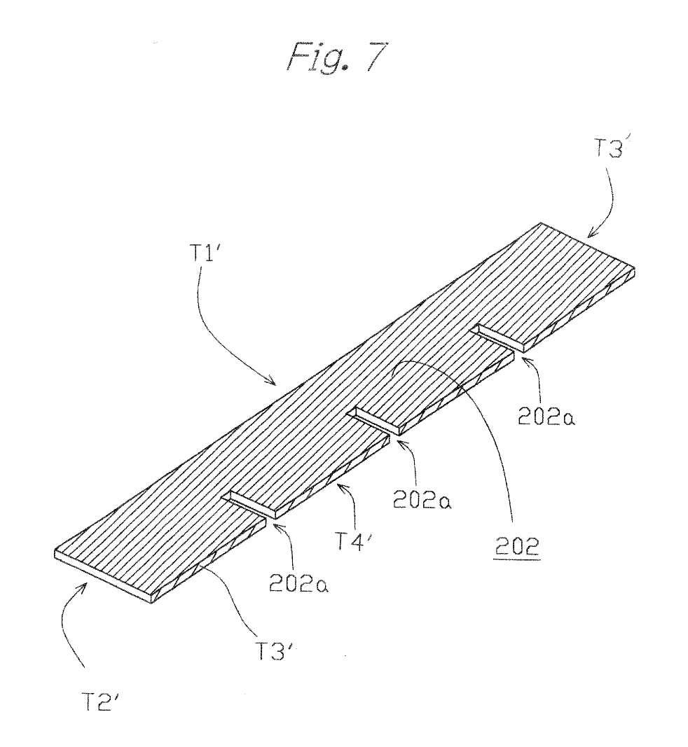

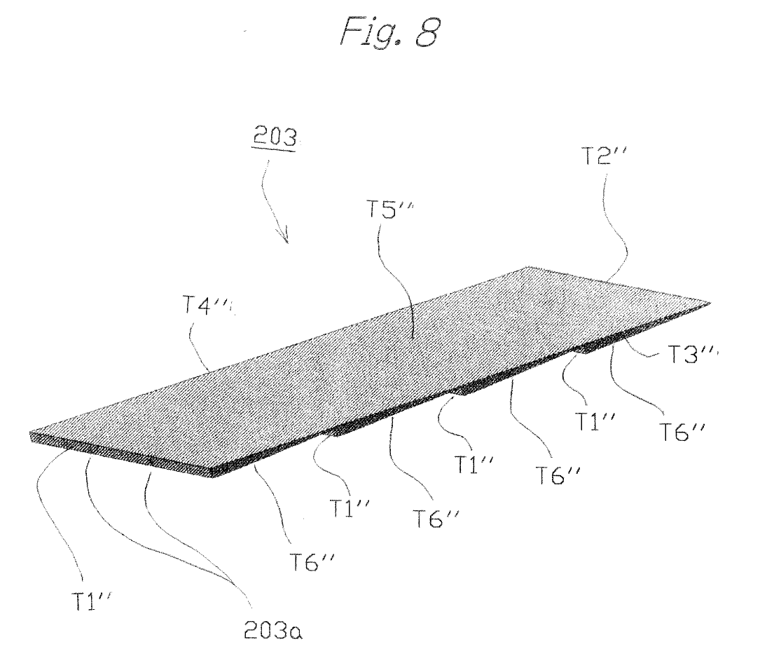

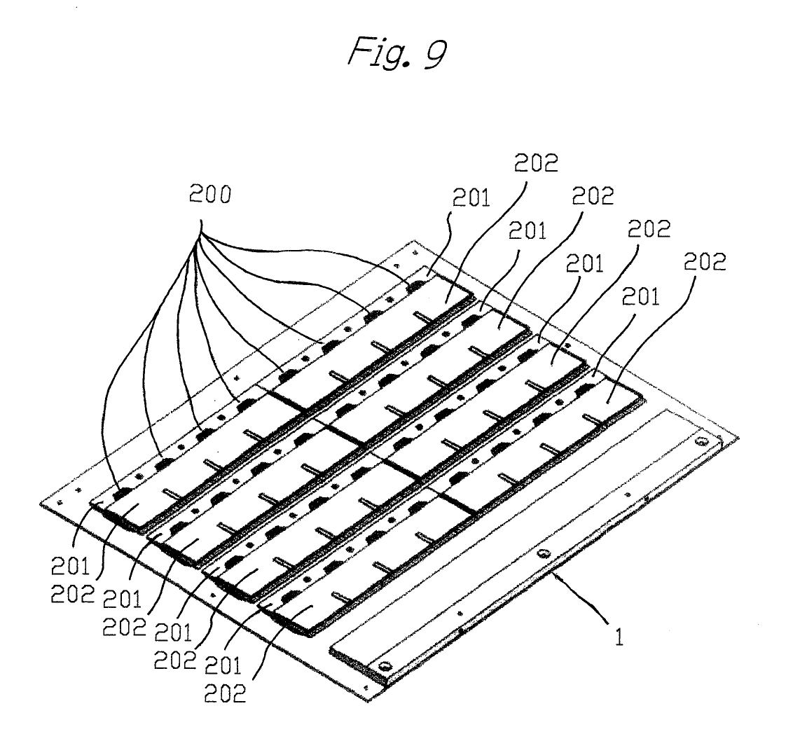

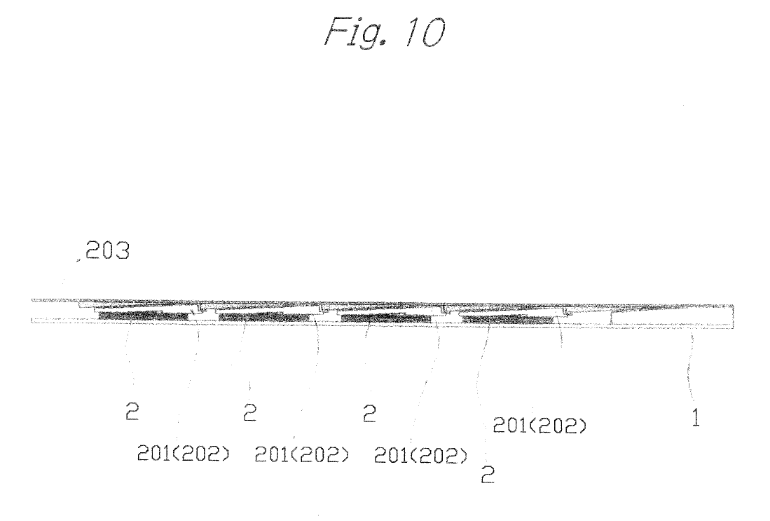

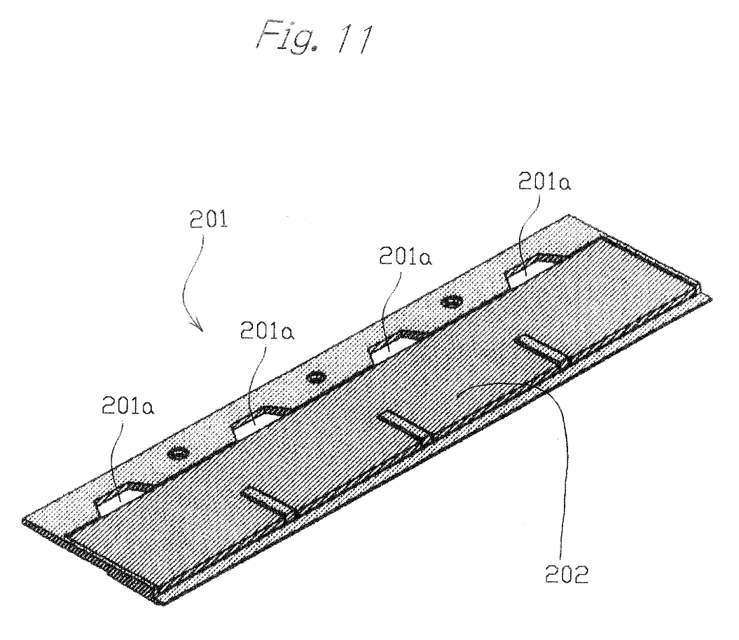

### BRIEF DESCRIPTION OF THE DRAWINGS

[FIG. 1] Plan views of light guide plate module according to the present invention.

[FIG. 2] A table showing the output luminous flux of the light guide plates of (A), (B) and (C) of FIG. 1 mounted on a surface light source apparatus with and without a reflective element.

[FIG. 3] A perspective view illustrating a first embodiment of the surface light source apparatus according to the present invention.

[FIG. 4] A cross-sectional view of the surface light source apparatus of FIG. 3.

[FIG. 5] A perspective view illustrating the light guide plate of FIG. 3.

[FIG. 6] A perspective view illustrating the reflective element of a second embodiment of the surface light source apparatus according to the present invention.

[FIG. 7] A perspective view illustrating the color-mixing element of the second embodiment of the surface light source apparatus according to the present invention.

[FIG. 8] A perspective view illustrating the available element of the second embodiment of the surface light source apparatus according to the present invention.

[FIG. 9] A perspective view of a part of a surface light source apparatus into which the white highly-reflective element as illustrated in FIG. 6 and the color-mixing element as illustrated in FIG. 7 are combined.

[FIG. 10] A cross-sectional view illustrating the surface light source apparatus of FIG. 9 into which an available element is combined.

[FIG. 11] A perspective view illustrating a modification of FIGS. 6 and 7.

[FIG. 12] A perspective view illustrating an already-suggested surface light source apparatus.

[FIG. 13] A cross-sectional view of the surface light source apparatus of FIG. 12.

[FIG. 14] A perspective view of the light guide plate of FIG. 12.

[FIG. 15] A cross-sectional view of the light guide plates for explaining the problems of the surface light source apparatus of FIG. 16.

### MODE FOR CARRYING OUT THE INVENTION

FIG. 1 is plan views illustrating light guide plate modules according to the present invention. Note that one light guide plate module is a combination of one light guide plate and a highly-reflective layer (element). In any of (A), (B) and (C) of FIG. 1, a light guide plate is made of transparent resin such as polymethylmethacrylate (PMMA), glass or the like, is partitioned into a color-mixing region R1 and an available region R2.

In (A) of FIG. 1, a white highly-reflective layer 101 is formed at both ends of a light incident edge face of the color-mixing region R1 of the light guide plate to surround an LED 100. In this case, the white highly-reflective layer has a cutout 101a for accommodating the LED. Also, if the light guide plate is made of transparent polymethylmethacrylate (PMMA) and the white highly-reflective layer 101 is made of white polymethylmethacrylate (PMMA) such as Acrylite (trademark) manufactured by Mitsubishi Rayon Co. , Ltd., the boundary between the color-mixing region R1 of the light guide plate and the white highly-reflective layer 101 forms a reflective face having a reflectivity of 88 percent. Note that screw holes 101b and 101c are used for fixing the light guide plate.

The integrated structure of the light guide plate and the white highly-reflective layer 101 in (A) of FIG. 1 can be realized by a double molding of polymethylmethacrylate (PMMA) for forming the light guide plate and white polymethylmethacrylate (PMMA) for forming the white highly-reflective layer 101.

In (B) of FIG. 1, an overhung portion 102 is overhung from both ends of a light incident edge face of the color-mixing region R1 of the light guide plate by the same material thereof to surround an LED 100, and a white highly-reflective layer 103 is formed at terminals of the overhung portion 102. For example, if the light guide plate is made of polymethylmethacrylate (PMMA) and the white highly-reflective layer 103 is made of highly-reflective microcellular polyethylene terephthalate (PET) such as Lumirror E6SV (trademark) manufactured by Toray Industries, Inc., the boundary between the color-mixing region R1 of the light guide plate and the white highly-reflective layer 103 forms a reflective face having a reflectivity of 97 percent.

The integrated structure of the light guide plate and the white highly-reflective layer 103 in (B) of FIG. 1 can be realized by molding or cutting polymethylmethacrylate (PMMA) to form a light guide plate including an overhung portion 102, and laminating polyethylene terephthalate (PET) by bonding or welding to form the white highly-reflective layer 103.

In (C) of FIG. 1, an overhung portion 104 is overhung from both ends of a light incident edge face of the color-mixing region R1 of the light guide plate by the same material thereof to surround an LED 100, and a specular highly-reflective layer 105 made of metal such as silver (Ag) or aluminum (Al) is formed at terminals of the overhung portion 104. For example, if the light guide plate is made of polymethylmethacrylate (PMMA) and the specular highly-reflective layer 105 is made of Ag film, the boundary between the color-mixing region R1 of the light guide plate and the specular highly-reflective layer 105 forms a reflective face having a reflectivity of 94.2 percent.

The integrated structure of the light guide plate and the specular highly-reflective layer 105 in (C) of FIG. 1 can be realized by molding or cutting polymethylmethacrylate (PMMA) to form a light guide plate including an overhung portion 104, and then, forming or coating Ag or Al to form the specular highly-reflective layer 105.

FIG. 2 is a table for showing the output luminous flux characteristics where the light guide plate of (A), (B) or (C) of FIG. 1 is mounted on a surface light source apparatus with and without an reflective element. In any case, the size of the color-mixing region R1 is 25.0 mm in the traverse direction×23.9 mm in the longitude direction, and the size of the available region R2 is 26.9 mm in the traverse direction×23.9 mm in the longitude direction.

As illustrated in FIG. 2, in the case of (A) of FIG. 1, if the size of the white highly-reflective layer 101 is 8.2 mm in the traverse direction×8.2 mm in the longitude direction, the output luminous flux without the white highly-reflective layer 101 is 1.56 lm, while the output luminous flux with the white highly-reflective layer 101 is 1.81 lm, thus improving the output luminous flux by 16 percent.

As illustrated in FIG. 2, in the case of (B) of FIG. 1, if the size of the overhung portion 102 is 8.2 mm in the traverse direction×8.2 mm in the longitude direction, the output luminous flux without the white highly-reflective layer 103 is 1.55 lm, while the output luminous flux with the white highly-reflective layer 103 is 1.69 lm, thus improving the output luminous flux by 9 percent.

As illustrated in FIG. 2, in the case of (C) of FIG. 1, if the size of the overhung portion 104 is 5.0 mm in the traverse direction×8.2 mm in the longitude direction, the output luminous flux without the specular highly-reflective layer 105 is 1.64 lm, while the output luminous flux with the white highly-reflective layer 105 is 1.74 lm, thus improving the output luminous flux by 6 percent.

FIG. 3 is a perspective view illustrating a first embodiment of the surface light source apparatus according to the present invention.

In FIG. 3, 3×4 partitioned tandem light guide plate modules 411a, 412a, 413a, 414a, 421a, 422a, 423a, 424a, 431a, 432a, 433a and 434a as illustrated in (A) of FIG. 1 are optically-independently fixed on an LED mounting substrate 2 by screws (not shown). In FIG. 3, note that the LED mounting substrate 2 is provided on a housing (not shown), and an optical sheet such as a diffusion plate, a prism sheet, a reflective polarizer plate or the like (not shown) is mounted on the light guide plate modules 411a, 412a, 413a, 414a, 421a, 422a, 423a, 424a, 431a, 432a, 433a and 434a. Also, reference numerals 311, 321 and 331 designate cutouts for accommodating LEDs.

FIG. 4 is a cross-sectional view of the surface light source apparatus of FIG. 3.

As illustrated in FIG. 4, the light guide plate modules 411a, 412a, 413a and 414a are superposed onto each other, and reflective films (not shown) are inserted therebetween so that leakage light which cannot be guided at a pre-stage light guide plate is reflected by the pre-stage light guide plate without being incident to a post-stage light guide plate.

Also, each LED (not shown) is mounted to be located within the white highly-reflective layers 101 to face the incident edge faces of the light guide plate modules 411a, 412a, 413a and 414a.

FIG. 5 is a perspective view of the light guide plate module such as 411a of FIG. 3.

As illustrated in FIG. 5, in the same way as in the light guide plate 411 of FIG. 14, the light guide plate module such as 411a has a light incident edge face T1 for receiving light emitted from a plurality of LEDs, an opposite light incident edge face T2, a planar face T3, a sloped face T4, a light emitting face T5, a side face T6, a side face T7 and a bottom face T8. The sloped face T4, a part of the side face T6 and a part of the side face T7 form a color-mixing region R1, and the light emitting face T5, the remainder of the side face T6 and the remainder of the side face T7 form an available region R2. However, a white highly-reflective layer 101 is provided at the light incident edge face T1, which is different from the light guide plate 411 of FIG. 4.

In the surface light source apparatus of FIGS. 3 and 4, since the light guide plate module of (A) of FIG. 1 is used, the output luminous flux can be improved.

In FIGS. 3 and 4, note that the light guide plate module of (B) of FIG. 1 or the light guide plate module of (C) of FIG. 1 can be used instead of the light guide plate module of (A) of FIG. 1.

FIGS. 6, 7 and 8 illustrate a second embodiment of the surface light source apparatus according to the present invention. Concretely, FIG. 6 illustrates a white highly-reflective element 201 where four light-adjusting areas are integrated (four-chain-connected) by one element, for example, FIG. 7 illustrates a four-chain-connected color-mixing element 202 of alight guide plate, for example, and FIG. 8 illustrates a one-piece available element of the light guide plate. That is, in the second embodiment of the present invention, a plurality of white highly-reflective elements 201 of FIG. 6 such as eight white highly-reflective elements, a plurality of the color-mixing elements 202 of FIG. 7 such as eight color-mixing elements and one available element 203 of FIG. 8 are combined to form a surface light source apparatus. Thus, the number of components can be reduced, and therefore, the manufacturing cost can be reduced.

As illustrated in FIG. 6, the white highly-reflective elements 201 are formed of highly-reflective polycarbonate such as Tarflon URC 250 manufactured by Idemitsu Kosan Co., Ltd. and Iupilon EHR3100 manufactured by Mitsubishi Engineering Plastics, Inc., and have cutouts 201a for accommodating LEDs, sidewalls 201b for surrounding and supporting the color-mixing element 202, protrusion walls 201c for intermeshing the color-mixing element 202 of FIG. 7, and protrusions 201d for matching the light incident edge face of the color-mixing element 202 of FIG. 7.

As illustrated in FIG. 7, the color-mixing element 202 is formed of polymethylmethacrylate (PMMA), and has cutouts 202a for intermeshing the protrusion walls 201c of the white highly-reflective element 201 of FIG. 6. Further, the color-mixing element 202 has a light incident edge face T1′ for receiving light emitted from LEDs, side faces T2′ and T3′ for color-mixing light incident from the light incident edge face T1′, and a light emitting face T4′ for emitting guided light.

As illustrated in FIG. 8, the available element 203 is formed of polymethylmethacrylate (PMMA), for example, and has a light incident edge face T1″ for receiving light emitted from the color-mixing element 202 of FIG. 7, an opposite light incident edge face T2″, side faces T3″ and T4″ for guiding light incident from the light incident edge face T1″, a light emitting face T5″ for emitting guided light, and a bottom face T6″. Note that slim notches 203a are provided at the boundaries between the light-adjusting areas to limit leakage light from their adjacent light-adjusting areas.

FIG. 9 is a perspective view of a surface light source apparatus into which the white highly-reflective element as illustrated in FIG. 6, the color-mixing element as illustrated in FIG. 7 and the available element 203 as illustrated in FIG. 8 are combined, and FIG. 10 is a cross-sectional view of FIG. 9. That is, an LED mounting substrate 2 is provided in a housing 1 as illustrated in FIGS. 9 and 10, and LEDs 200 as primary light sources are mounted on the LED mounting substrate 2. Combined on the housing 1 and the LED mounting substrate 2 are eight of the white highly-reflective elements 201 as illustrated in FIG. 6, eight of the color-mixing elements 202 as illustrated in FIG. 7, and one available element 203 as illustrated in FIG. 8, sequentially. Note that the available element 203 is omitted from FIG. 9.

FIG. 11 is a perspective view illustrating a modification of FIGS. 6 and 7.

As illustrated in FIG. 11, the white highly-reflective element 201 as illustrated in FIG. 6 and the color-mixing element 202 as illustrated in FIG. 7 can be of an integrated structure formed by a double molding using highly-reflective polycarbonate (PC) and transparent polymethylmethacrylate (PMMA). Thus, the number of components can be further reduced, and therefore, the manufacturing cost can be further reduced.

In FIGS. 6, 7 and 8, the light guide plate module as illustrated in (B) of FIG. 1 or the light guide plate module as illustrated in (C) of FIG. 1 can be used. In this case, instead of the light incident edge face T1′ of the color-mixing element 202 of the white highly-reflective element 201, an overhung portion is provided at the color-mixing element 202, and a white highly-reflective layer of expanded polyethylene terephthalate (PET) or a specular highly-reflective layer of Ag film or the like is formed at the overhung portion.

### DESCRIPTION OF THE SYMBOLS

1: housing

2: LED mounting substrate

311, 312, 313, 314: LEDs

400: initial-stage reflective plate

411, 412, 413, 414, 421, 422, 423, 424: light guide plates

511, 512, 513, 514, 515: reflective films

6: diffusion plate

711, 712, 713, 714: LED accommodating regions

100: LED

101: white highly-reflective layer

102: overhung portion

103: white highly-reflective layer

104: overhung portion

105: highly-reflective layer

200: LED

201: white highly-reflective element

201a: LED accommodating region

201b: sidewall

201c: protrusion wall

201d: protrusion

202: color-mixing elements

203: available element

1. A surface light source apparatus comprising:
at least one primary light source;
a reflective element formed to surround said primary light source; and
a light guide plate having a light incident edge face for receiving primary light from said primary light source, side faces for guiding light incident to said light incident edge face, an opposite light incident edge face located to oppose said light incident edge face, and a light emitting face for emitting guided light.

2. The surface light source apparatus as set forth in claim 1, wherein said reflective element comprises white resin, and said light guide plate comprises transparent resin.

3. The surface light source apparatus as set forth in claim 2, wherein said reflective element and said light guide plate are integrated by a double molding.

4. The surface light source apparatus as set forth in claim 1, wherein said reflective element comprises white polyethylene terephthalate (PET), and said light guide plate comprises transparent resin.

5. The surface light source apparatus as set forth in claim 4, wherein said reflective element is bonded or welded on an overhung portion of the light incident edge face of said light guided plate.

6. The surface light source apparatus as set forth in claim 1, wherein said reflective element comprises an element formed by growing a metal film on transparent resin, and said light guide plate comprises transparent resin.

7. The surface light source apparatus as set forth in claim 6, wherein said reflective element is grown or bonded on an overhung portion of the light incident edge face of said light guided plate.

8. The surface light source apparatus as set forth in claim 1, wherein said light guide plate comprises:
a color-mixing element including said light incident edge face and a part of said side faces, and
an available element including the remainder of said side faces, said opposite light incident edge face and said light emitting face.

9. The surface light source apparatus as set forth in claim 8, wherein said reflective element comprises white resin, and said color-mixing element comprises transparent resin.

10. The surface light source apparatus as set forth in claim 9, wherein said reflective element and said color-mixing element are integrated by a double molding.

11. A surface light source apparatus including a plurality of tandem-arranged light guide plate modules, each of said light guide plate modules comprising:
at least one primary light source;
a reflective element formed to surround said primary light source; and
a light guide plate having a light incident edge face for receiving primary light from said primary light source, side faces for guiding light incident to said light incident edge face, an opposite light incident edge face located to oppose said light incident edge face, and a light emitting face for emitting guided light.

12. The surface light source apparatus as set forth in claim 11, wherein said light guide plate comprises:
a color-mixing element including said light incident edge face and a part of said side faces, and
an available element including the remainder of said side faces, said opposite light incident edge face and said light emitting face.

13. The surface light source apparatus as set forth in claim 11, where said reflective element has a sidewall for surrounding and supporting said color-mixing element.

14. The surface light source apparatus as set forth in claim 12, wherein said reflective element has a protrusion wall for intermeshing said color-mixing element.

15. The surface light source apparatus as set forth in claim 12, wherein said reflective element has a sidewall for matching the light incident face of said color-mixing element.

16. The surface light source apparatus as set forth in claim 11, wherein said reflective element comprises white resin, and said light guide plate comprises transparent resin.

17. The surface light source apparatus as set forth in claim 16, wherein said reflective element and said light guide plate are integrated by a double molding.

18. The surface light source apparatus as set forth in claim 11, where said reflective element comprises an element formed by growing a metal film on transparent resin, and said light guide plate comprises transparent resin.

19. The surface light source apparatus as set forth in claim 18, wherein said reflective element is grown or bonded on an overhung portion of the light incident edge face of said light guided plate.

20. The surface light source apparatus as set forth in claim 19, wherein said reflective element comprises white resin, and said color-mixing element comprises transparent resin.

21. The surface light source apparatus as set forth in claim 20, wherein said reflective element and said color-mixing element are integrated by a double molding.

22. The surface light source apparatus as set forth in claim 12, wherein a plurality of said reflective elements are integrated and a plurality of said color-mixing elements are integrated, said available elements being integrated into one piece.
